(19) United States
(12) Patent Application Publication
(10) Pub. No.: US 2012/0236715 A1
(43) Pub. Date: Sep. 20, 2012

(54) Measurement Based Admission Control Using Explicit Congestion Notification In A Partitioned Network

(75) Inventors: Michael Vitt, Ocean, NJ (US); George F. Elmasry, Howell, NJ (US)

(73) Assignee: D & S CONSULTANTS, INC., Eatontown, NJ (US)

(21) Appl. No.: 13/050,646

(22) Filed: Mar. 17, 2011

(51) Int. Cl. H04L 12/26

(52) U.S. Cl. 370/230

(57) ABSTRACT

A device and method for implementing a measurement based admission control (MBAC) protocol consists of various devices having software modules running thereon which are capable of calculating a congestion level based upon the detection of incoming packets having Explicit Congestion Notification (ECN) bits set by one or more routers in an encrypted core domain of a partitioned network. Upon detecting a certain congestion level at an egress edge of the network, a UDP packet is transmitted back to the ingress edge of the network wherein certain types or percentages of certain types of packets are blocked to relieve the congestion on the network. Once the congestion level on the network falls below a certain level, those packets may be transmitted.

### FIELD OF THE INVENTION

The general field of art includes computer systems that run over a partitioned network, and, in particular, over a tactical network partitioned into a plain text (unencrypted) domain and cipher text (encrypted) domain.

### BACKGROUND OF THE INVENTION

The dynamic nature of tactical networks requires adaptive techniques that are aware of the changes in each of the protocol stack layers and are capable of reacting to those changes to optimize the limited network resources. Cross-layer signaling has shown that passing valuable information between the protocol stack layers can result in good optimization of network resources, thereby achieving gains in throughput, reliability and Quality of Service (QoS) metrics.

In particular, the information can be used to perform Measurement Based Admission Control (MBAC), which can regulate traffic entering the network, and thereby alleviate congestion. This is achieved by blocking network sessions during periods of congestion, to improve the performance of the network by reducing bandwidth consumption. Most current MBAC solutions use time stamps to measure delay and thus determine if congestion exists. This approach suffers from several deficiencies, especially in the context of a partitioned tactical network.

First, using time-stamp derived delay data to calculate congestion is not very accurate because all delays are not necessarily caused by congestion. For example, an observed increase in delay could be caused by the degradation of a wireless network link. In this case, blocking sessions would not improve performance of the network. In fact, it would actually decrease performance since packets would be dropped without any benefit.

Furthermore, to use this method, the delay must be experienced over a period of time to help ensure that the delay is being caused by congestion. Otherwise, oscillation can occur when the edge software tries to correct the problem. This happens when the MBAC algorithm blocks too many sessions, which causes under-utilization of the network. In response, too many sessions could start again, causing a burst of congestion. This cycle could then repeat indefinitely. Therefore, an MBAC solution based on time stamps would not be able to react very quickly when congestion does exist.

Finally, the transfer of packet time stamps requires additional bandwidth. The time stamp could be added to all or a sample of packets. Alternatively, new packets could be generated to pass time stamps between MBAC software modules located at the network edge. The additional bandwidth requirements can be a problem for tactical networks, which often have very limited bandwidth (such as satellite links).

To be effective, MBAC methods require accurate congestion information and most current solutions are deficient in the context of a partitioned tactical network due to the challenges presented. These challenges make it difficult to efficiently utilize the network as the condition of the network is unknown, often resulting in a degradation of overall network performance.

### SUMMARY OF THE INVENTION

The invention is a software module that runs on a computer system acting as an ingress network edge device, which is connected to or incorporates an encryption device such as a HAIPE (High Assurance Internet Protocol Encryptor). The encryption device is connected to at least one router, which has support for the Explicit Congestion Notification (ECN) protocol. In a tactical network, the router is typically located in the encrypted core domain of the partitioned network. Eventually, the network path must connect to another encryption (decryption) device at the other side of the encrypted core domain. Finally, this encryption device must connect to another computer system acting as an egress edge device that is also running the software module of the invention. The complete network path from one edge device to the other edge device contains all of the required elements.

The ECN bits of network packets can be used to pass valuable information between the partitions of tactical networks that allow those bits to cross the partition boundaries. For example, tactical networks that use HAIPE devices with a firmware version of 3.1 or higher allow the ECN bits to cross partition boundaries. The method of the present invention using ECN is able to obtain accurate and timely information, as the congestion state is provided directly by the router(s) along the path. Because the congestion state is accurate, the method can react more quickly to the problem of congestion without causing oscillation or dropping packets due to a link degradation. Additionally, the ECN information does not require any additional bandwidth because the 2 bits utilized by ECN already exist in the network packets.

In accordance with this invention, the ECN information can be used by the method to overcome the limitations of network partitions and thus utilize the tactical networks more efficiently.

The method of the present invention using ECN requires at least two computer systems running the software module. The software modules communicate with each other, where changes in the current congestion state are reported. The first software module intercepts all outgoing network packets and sets a bit that enables ECN detection. The packet is processed by at least one router along the network path that has support for ECN. If the packet queue at the router exceeds a user-defined limit, a second bit is set by the router in the packet, which signals congestion.

The second software module intercepts all incoming network packets. The congestion bit is read by the software module and used to calculate a congestion percentage corresponding to a predetermined congestion level for a particular type of network traffic. As a result, the second software module has an accurate congestion percentage for the network path between both computer systems running the modules.

If the percentage of received packets at the egress edge indicating congestion exceeds a user-definable threshold for a user-definable amount of time, the congestion level can be increased. This change in congestion level can be sent from the egress edge device to the ingress edge device using a UDP network packet. The first module can then utilize this information to block network sessions to alleviate the congestion. Over time, this blocking action will decrease the percentage of received packets indicating congestion.

As the percentage of incoming packets indicating congestion decreases, the congestion level can be decreased. The ingress edge device is notified of the decrease in congestion level and certain network sessions will no longer be blocked. Thus, the network is able to perform optimally even though a partition preventing direct access to the network statistics of the router(s) along the network path exists.

The actual congestion policy enforced at the ingress edge can be optimized for each particular network, and the modules contain a default policy that handles congestion relief, using a generalized algorithm.

In an algorithm of one embodiment of the invention, packets are categorized according to traffic type (e.g., data, voice, and video) and importance (e.g., routine, priority, immediate, flash and flash override). Each priority level is associated with a corresponding congestion level at or below which the packets will be transmitted and at or above which the packets will be blocked. Each traffic type is treated independently of other traffic types, and a separate congestion level may be calculated for each type.

A congestion threshold at the egress edge can be configured to determine when the congestion level should be increased. For example, 10 percent congestion of routine packets for 2 seconds could result in an increase of the congestion level to the next level. The thresholds used to make this determination need not be the same for each traffic type.

In general, the congestion level can be related to the packet importance that is currently experiencing congestion. A congestion level of 0 would indicate that no congestion is being detected, and no sessions would be blocked. At a congestion level of 1, new routine sessions would be denied, including routine RSVP and SIP reservation requests. Additionally, a percentage of existing routine sessions may be blocked until congestion is relieved.

The start, stop, increment, and time parameters of blocking can be configurable. For instance, the policy could initially block 20 percent of routine sessions and then increment by 10 percent every 12 seconds up to 90 percent max as long as congestion persists.

If the congestion level increases to 2, this would indicate that priority packets are also experiencing congestion. This would result in all lower importance packets being blocked, which in this case would be all routine sessions. A congestion level of 3 would cause priority sessions to be blocked over time. New priority sessions would be denied, as well as priority RSVP and SIP reservation requests. This would continue in the same pattern up to immediate importance. In certain embodiments, flash and flash override packets may never be blocked because they are usually very important packets, however, in certain other implementations, flash and flash override packets may be blocked as well.

As a result of the blocking, the number of packets received at the egress edge indicating congestion would decrease over time, and, as a result, the congestion level would be decreased over time. By default, congestion levels can decrease if congestion is not experienced for a given packet importance for 10 seconds, but this time period is configurable. For instance, if immediate importance packets do not experience congestion of 10 percent or higher for 10 seconds, the congestion level could decrease. This process would continue until the congestion requirements to decrease are no longer met, indicating a further increase in congestion, or the congestion level drops down to 0, which is the initial value. Each time the congestion level changes, either upward or downward, a UDP packet is sent from the egress edge to the ingress edge, informing the ingress edge of the change.

In one novel aspect of the invention, this congestion policy helps relieve congestion according to the importance of packets. It makes effective use of the ECN congestion information to improve the performance of partitioned, tactical networks, and also allows integration with reservation protocols such as RSVP and SIP. The congestion policy can be tailored to each network, using the core functionality that exists. In addition, the default policy can be used and configured as desired by the user.

### DESCRIPTION OF THE DRAWINGS

FIG. 1 shows a typical prior art tactical network.

FIG. 2 shows a schematic diagram of the components of the present invention.

### DETAILED DESCRIPTION OF THE INVENTION

In the primary embodiment of the invention the congestion level at the egress edge of the network is calculated based on the traffic type (i.e., data, video & voice). The congestion levels for all traffic types are sent back to the ingress edge device via a UDP packet.

To calculate the congestion level, at the egress edge device, the percentage of received packets having the “congestion encountered” (CE) condition set within a given period of time is calculated for each traffic type. The congestion percentage is calculated first for higher priority traffic. Priority levels with each class range may be, for example, “routine” (lowest), “priority,” “immediate,” “flash,” and “flash override.”

For example, if the current congestion level is indicating congestion for routine traffic for a particular traffic type, and the incoming packets at the egress edge device indicate that congestion is being detected for priority traffic for that type of traffic, the congestion level for that type may be raised to “priority.”

In general, the egress edge device follows the following rules. First, continue to increase the congestion level if congestion exits for packets at priority levels above the current congestion level. This would cause the ingress edge device to block 100% of sessions below the congestion level to help relieve congestion for more important packets. As an example, if congestion exists for priority packets, the ingress edge device would cause all routine packets to be blocked. If congestion exists for immediate packets, then all priority and routine packets will be blocked.

Second, continue to block a percentage of the sessions at the current level as long as congestion exists. As an example, a percentage of routine packets may be blocked to relieve congestion of other routine packets.

Lastly, when neither of the conditions are met, the congestion level can be decreased until it reaches zero, which is the idle state.

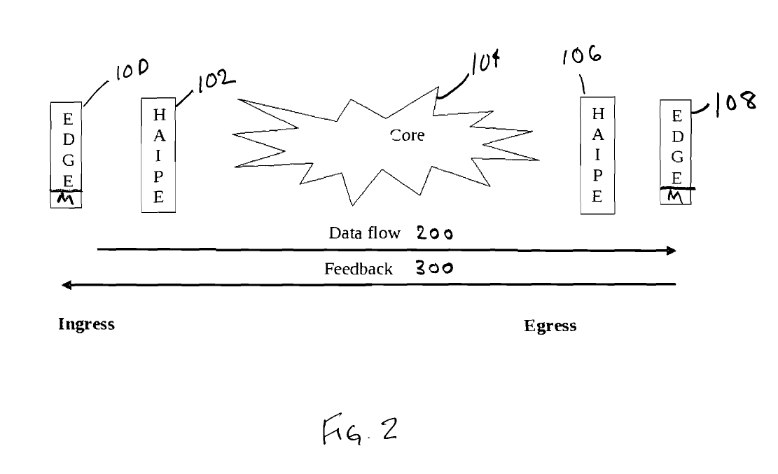

FIG. 2 shows operation of the method of the present invention in schematic form.

Referring to FIG. 2, ingress edge computer 100 is running module M of the present invention. For an outgoing data packet 200, the ECN capable transport bit (ECN1) is set. The packet is passed to encryption device 102 which, in the preferred embodiment of the invention, is a HAIPE compliant device. Packet 200 is then sent into the encrypted core domain 104 of the network, where it will encounter at least one, and possibly more than one, router as it makes its way through the encrypted core domain. If any router in the encrypted core domain is experiencing congestion, the router will toggle the ECN “congestion experienced” flag (CE flag or the ECN2 bit setting it to 1). Packet 200 then exits the encrypted core domain 104 and proceeds to encryption (decryption) module 106, where it is decrypted and sent in plain text form to egress edge device 108, running module M of the present invention.

When egress edge computer 108 detects a level of ECN markings indicating congestion that exceeds a predetermined threshold for a particular type of packets, the congestion level for that type of packet is increased. The packets may be segregated via type and/or priority, with the types being data, voice and video, and the priorities being routine, priority, immediate, flash and flash override. In the preferred embodiment of the invention, a separate congestion level is calculated for each type of traffic, with the congestion levels corresponding to the priority levels of the packets.

As an example, if packets received by egress edge device 108 having the congestion encountered flag set exceeds 10% of all packets received within a two second window having traffic of type voice and importance level routine, then the congestion level is set at routine for voice type packets. Similarly, if the same threshold is reached for voice packets having an importance level of priority, then the congestion level may be set to priority. The threshold in terms of percentage of packets having the ECN congestion encountered flag set and the time period during which the packets are sampled to determine if there is congestion, are configurable and preferably are able to be set differently for each type packet and for each importance level for each different type of packet.

When there is a change in the congestion level for any particular type of traffic, the egress edge device 108 sends feedback information 300, preferably via a UDP packet, to ingress edge device 100. Ingress edge device 100 uses this information to enforce a policy which blocks selected transmissions of packets.

The policy implemented at ingress edge device 100 is as follows: for each congestion level corresponding to a priority level of packets for a particular type, all packets having a priority level below the current congestion level are blocked. A configurable percentage of the packets will be transmitted for packets having a priority level equal to the current congestion level. For packets having a priority level above the current congestion level, no blocking is experienced. The UDP packet received by ingress edge device 100 may indicate a change in the congestion level when the congestion level is either increased or decreased. Ingress edge device 100 utilizes the current congestion level to implement the policy outlined above.

It should be noted that ingress edge device 100 and egress edge device 108 as shown in FIG. 2 may be one of many such devices in the partitioned tactical network, and are, in reality edge devices which act as both ingress and egress edge devices and which allow data transmission both ways. As such, each also will receive a feedback from the receiving edge. The software module M implementing the present invention serves both to set the congestion level based upon incoming packets and to implement the policy for outgoing traffic via feedback 300 received via the incoming UDP packets.

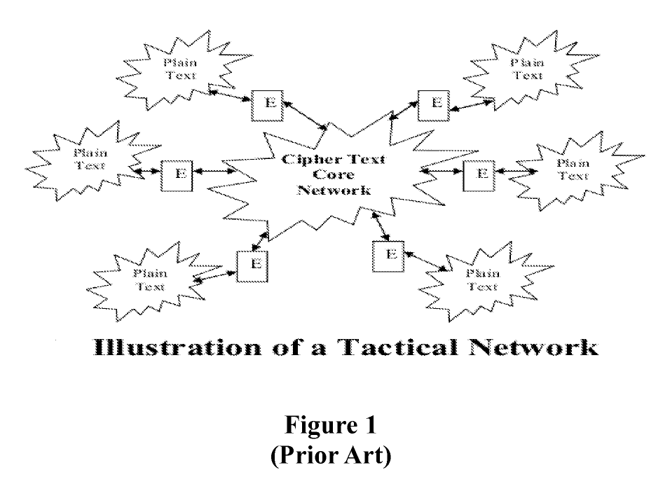

It should be noted that edge devices 100 and 108 are typically stand alone computers. However, they may also be dedicated devices providing a gateway to plain text domains as shown in FIG. 1. In addition, encryption modules 102 and 106 may be implemented as separate devices or may be a part of edge devices 100 and 108, respectively. The only further restriction is that the encrypted core domain 104 contain at least one router capable of detecting congestion and setting the ECN bits in response thereto.

We claim:

1. A system for implementing a measurement based access control protocol in a partitioned network comprising:
a first hardware device acting as an ingress edge to a core of said network, said first hardware device running software for performing the following functions:
(a) intercepting outgoing IP packets and enabling ECN for said packets;
(b) receiving incoming feedback packets, each of said feedback packets indicating a change in a current congestion level; and
(c) implementing a policy wherein outgoing packets are blocked, said policy being based on said current congestion level; and
a second hardware device acting as an egress edge to a core of said network, said second hardware device running software for performing the following functions:
(a) receiving incoming packets;
(b) tracking the percentage of said incoming packets indicating that congestion was encountered;
(c) calculating one or more congestion levels; and
(d) transmitting, via outgoing packets, said congestion levels to said first hardware device.

2. The system of claim 1 wherein said egress edge transmits said one or more congestion levels to said ingress edge only when one of said congestion levels changes.

3. The system of claim 1 wherein said egress edge calculates a congestion level for each type of packet received.

4. The system of claim 1 wherein each of said packets received at said egress edge has an associated priority level and further wherein said congestion levels calculated by said egress edge correspond to said priority levels.

5. The system of claim 4 wherein a congestion level is set to a certain priority level when a pre-set percentage of packets received at said egress edge over a pre-set time having said certain priority level indicate congestion.

6. The system of claim 5 wherein a congestion level is lowered to the next lowest level when the percentage of packets received over a pre-set time having said current priority level that indicate congestion is below a pre-set percentage.

7. The system of claim 2 wherein said changed congestion levels are transmitted to said ingress edge via a UDP packet.

8. The system of claim 2 wherein said ingress edge receives said changed congestion levels and sets the current congestion level to the received congestion level.

9. The system of claim 8 wherein said ingress edge blocks transmission of packets having a priority lower than said current congestion level.

10. The system of claim 8 wherein said ingress edge blocks transmission of a pre-set percentage of packets for a session having a priority level equal to said current congestion level.

11. The system of claim 10 wherein said ingress edge denies new sessions having a priority level equal to said current congestion level.

12. The system of claim 8 wherein said ingress edge transmits packets having a priority level above said current congestion level.

13. The system of claim 1 wherein said first hardware device and said second hardware device are the same device.

14. A method for implementing a measurement based access control protocol in a partitioned network, implemented as software running on a network edge device, comprising the steps of:
communicating a congestion level between an egress network edge device of said partitioned network and an ingress network edge device of said partitioned network;
implementing, at said ingress network edge device, a policy for blocking transmissions of certain packets, based on said communicated congestion level;
calculating, at an egress network edge device, the current congestion level based on a percentage of received packets over time indicating congestion in a core domain of said partitioned network, between said ingress and egress network edge devices;
wherein said indicator of congestion is the explicit congestion notification bits contained in each transmitted packet.

15. The method of claim 14 wherein said step of calculating further comprises the step of calculating a separate congestion level for each different defined type of packet.

16. The method of claim 14 wherein said ingress network edge device implements a policy comprising the steps of:
blocking transmission of packets having a priority level below said communicated congestion level;
blocking a pre-set percentage of packets having a priority level equal to said communicated congestion level; and
transmitting all packets having a priority level above said communicated congestion level.

17. The method of claim 14 further comprising, at said ingress network edge device, the step of intercepting all outgoing packets and enabling explicit congestion notification prior to transmission.

18. The method of claim 15 wherein said calculating step further comprises the steps of:
raising the congestion level to a higher priority level if a pre-set percentage of packets received over a pre-set period of time at the higher priority level have experienced congestion;
lowering the congestion level to a lower priority level if the percentage of packets received over a pre-set period of time at the current priority level falls below a certain percentage.
